(19) United States
(12) Patent Application Publication
(10) Pub. No.: US 2011/0216555 A1
(43) Pub. Date: Sep. 8, 2011

(54) LED DEVICE FOR BACKLIGHT MODULE

(75) Inventors: Chih-Hung WEI, Tu Cheng City (TW); Ming-Chang Wu, Tu Cheng City (TW); Chih-Lung Wu, Tu Cheng City (TW); Mei-Jung Chien, Tu Cheng City (TW)

(73) Assignee: High Power Lighting Corp.

(21) Appl. No.: 12/718,263

(22) Filed: Mar. 5, 2010

(51) Int. Cl. F21V 7/04

(52) U.S. Cl. 362/608

(57) ABSTRACT

A light emitting diode (LED) device applied to a backlight module includes a substrate, a plurality of sub-substrates, a plurality of light emitting chips, and a plurality of package lenses. The sub-substrates are installed on the substrate, and the light emitting chips are installed on the sub-substrates respectively. The package lenses are installed on the light emitting chips respectively, and each package lens is in a solid semi-elliptical shape and includes a long axis and a short axis perpendicular to the long axis.

### FIELD OF THE INVENTION

The present invention generally relates to a light emitting diode (LED) device, in particular to an LED device applied in a backlight module.

### BACKGROUND OF THE INVENTION

Since LED has the advantages of saving energy and protecting environments, therefore LED is used as a light source increasingly more in the area of backlight modules of liquid crystal display devices. The backlight module is mainly divided into bottom lighting and edge lighting according to the position of the light source with respect to a light guide plate.

With reference to FIG. 1, a conventional edge-lighting backlight module adopts an LED 10 as a light source, and the LED 10 is installed onto a side 12 (either a top side or a bottom side) of a light guide plate 11. Light is entered into the light guide plate 11 from a lateral side 12 of the LED 10 and transmitted within the light guide plate 11. Since the liquid crystal display tends to come with a thinner design, related components tend to have a thinner design as well.

However, the thin light guide plate 11 may cause a technical difficulty for the incident light. In FIG. 2, the light emitted from the LED 10 comes with a divergence angle, so that after the light enters into the light guide plate 11 from the lateral side 12 of the light guide plate 11, a portion of the light with a large angle will be refracted outwardly from an exit plane 13 to produce a partial bright area on the light guide plate 11 and at a position proximate to the LED 10 and result in a non-uniform brightness of the emitted light produced by the backlight module.

### SUMMARY OF THE INVENTION

Therefore, it is a primary objective of the present invention to provide an LED with asymmetric light divergence angles, such that a smaller light divergence angle is provided in an axial direction to overcome the aforementioned non-uniform light emitted from the backlight module.

To achieve the foregoing objective, the present invention discloses an LED device applied to a backlight module, and the LED device comprises a substrate, a plurality of sub-substrates, a plurality of light emitting chips, and a plurality of package lenses. The sub-substrates are installed on the substrate. The light emitting chips are installed on the sub-substrates respectively. The package lenses are installed onto the light emitting chips respectively, wherein each package lens is in a solid semi-elliptical shape and has a long axis and a short axis perpendicular to the long axis.

The present invention has the semi-elliptical package lens installed on the light emitting chip to provide asymmetric divergence angles to the light in order to overcome the aforementioned non-uniform light issue.

### BRIEF DESCRIPTION OF THE DRAWINGS

FIG. 1 is a schematic view of applying a conventional LED device in a backlight module;

FIG. 2 is a schematic view of applying another conventional LED device in a backlight module;

FIG. 3 is a schematic view of applying an LED device in a backlight module in accordance with the present invention;

FIG. 4 is a side view of applying an LED device in a backlight module in accordance with the present invention;

FIG. 5 is another side view of applying an LED device in a backlight module in accordance with the present invention; and

FIG. 6 is a further side view of applying an LED device in a backlight module in accordance with the present invention.

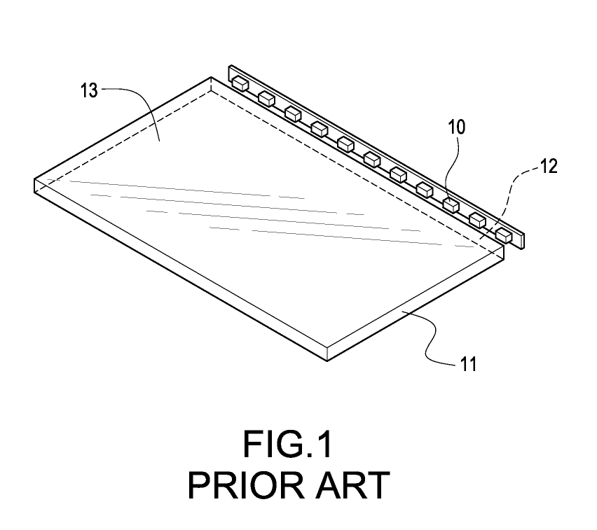

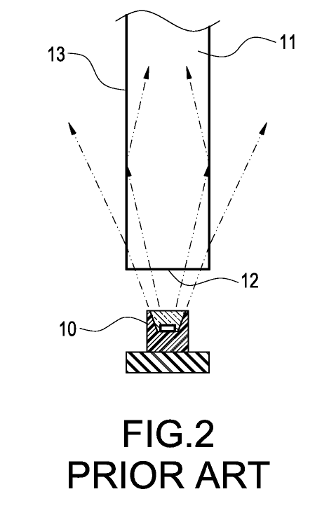

### DESCRIPTION OF THE PREFERRED EMBODIMENTS

The technical characteristics and contents of the present invention will become apparent with the following detailed description accompanied with related drawings.

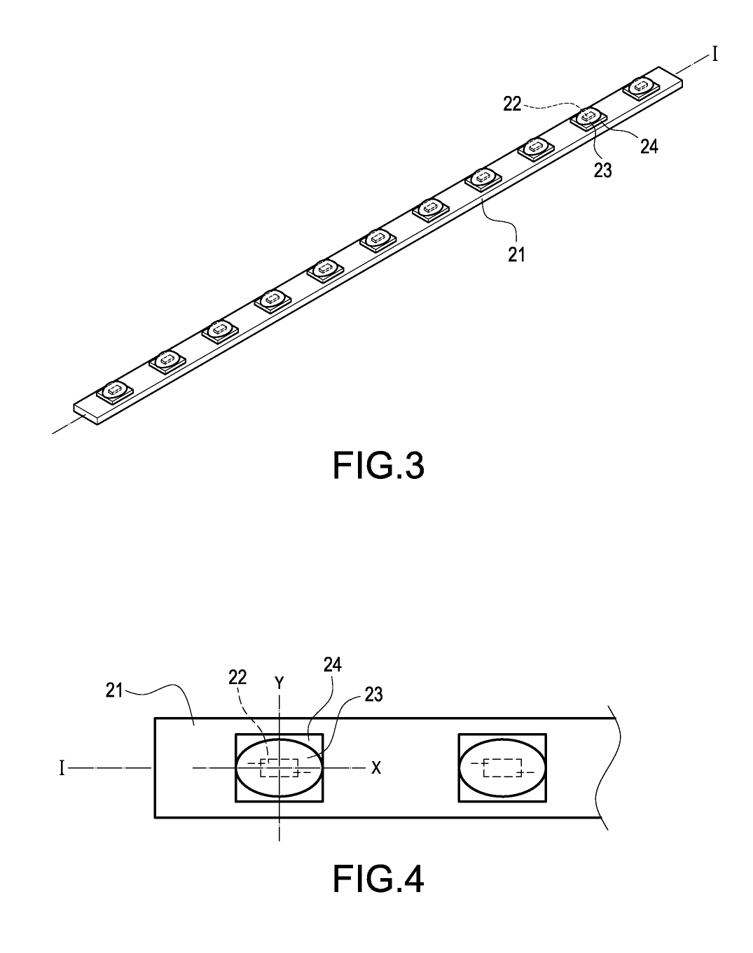

With reference to FIG. 3 for a schematic view of applying an LED device in a backlight module in accordance with a preferred embodiment of the present invention, the LED device comprises a substrate 21, a plurality of sub-substrates 24, a plurality of light emitting chips 22, and a plurality of package lenses 23, wherein the quantity of package lenses 23 is equal to the quantity of light emitting chips 22. It is noteworthy to point out that there are eleven light emitting chips 22 in this preferred embodiment, but any number greater than one of the light emitting chips 22 can be used other preferred embodiments of the present invention.

The substrate 21 can be a rigid or flexible printed circuit board, and it can be an aluminum substrate having a good heat dissipating efficiency, and the substrate 21 includes a plurality of circuits, and a plurality of contact points (not shown in the figure) electrically connected to the light emitting chip 22. In this preferred embodiment, the substrate 21 is in a rectangular shape having a long axis I, but the invention is not limited to such arrangement only.

The sub-substrates 24 are installed on the substrate 21, wherein the sub-substrate 24 is a rigid or flexible printed circuit board provided for carrying the light emitting chips 22 and the package lenses 23. Each sub-substrate 24 includes a circuit for electrically coupling the light emitting chip 23. The sub-substrates 24 can be electrically coupled to the substrate 21 by wire bonding or surface mounting.

One side of the sub-substrate 24 is provided for carrying the light emitting chips 22 and the package lenses 23, and another side of the sub-substrate is electrically coupled to the substrate 21, such that if any one of the light emitting chips 22 fails, the failed light emitting chip and those following it can be removed from the sub-substrate 24 and replaced by good ones. Since the process of removing the sub-substrates 24 from the substrate 21 is much simpler and more convenient than the conventional way that requires the removal of the light emitting chips from the substrate, therefore the invention can improve the way of removing and replacing a light emitting chip 22 when the light emitting chip 22 breaks down.

The light emitting chips 22 are installed with an interval apart from each other and on the sub-substrate 24 and electrically coupled to the sub-substrate 24. The electric connection depends on the type of the chip, whether it is a wire bonding chip or a flip-chip bonding chip. The light emitting chips 22 are LED chips made of a semiconductor material, and the color of its emitted light is not restricted to any particular color. Preferably, the light emitting chip 22 is a cuboid as shown in the figure, wherein the shape of the cuboid can provide a greater light emitting area to achieve a better light emitting efficiency.

With reference to FIG. 4, the package lenses 23 are contacted with and installed on the light emitting chips 22 for covering the light emitting chips 22 respectively. Each package lens 23 is in a solid semi-elliptical shape and has a long axis X and a short axis Y perpendicular to the long axis X, and the long axis X is substantially parallel to the of the long axis I of the substrate, and the long axis of the light emitting chip 22 is substantially parallel to the long axis X of the package lens 23. The package lens 23 is made of a transparent material such as silicone capable of passing through a visible light having a wave band of 400˜780 nm. In a practical application, the package lens 23 has a height h equal to or greater than 0.5 mm, and the length of the long axis X is greater than the length of the short axis Y. In addition, a phosphor is added into the package lens 23, such that the phosphor is scattered in the package lens 23 and provided for absorbing a portion of the light emitted from the light emitting chip 22 and converting the light into a light of another wavelength, so as to achieve a color mixing effect.

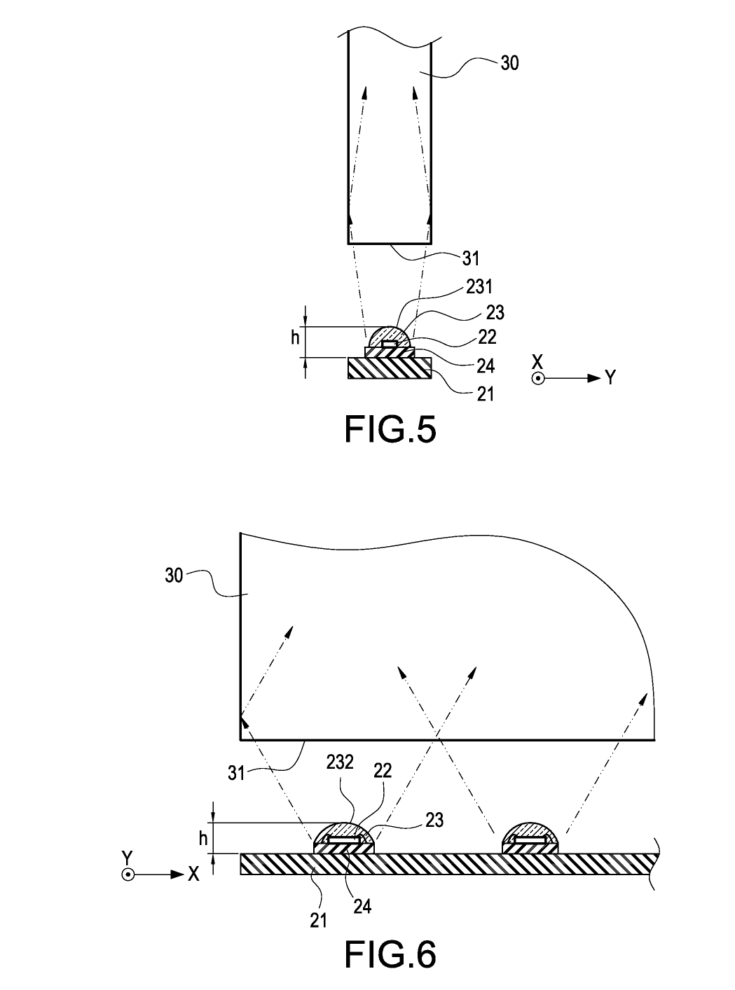

In FIGS. 5 and 6, the long axis X has a length greater than the length of the short axis Y, so that a cross-sectional upper edge 231 of the package lens 23 along the short axis Y as shown in FIG. 5 has a curvature smaller than the curvature of a cross-sectional upper edge 232 of the package lens 23 along the short axis X as shown in FIG. 6. Since the cross-sectional upper edge 231 having a smaller curvature as shown in FIG. 5 provides a smaller divergence angle to the light emitted from the light emitting chip 22, so that after the light is entered from a lateral surface 31 of the light guide plate 30 and projected onto the light guide plate 30, the light will not refracted towards the light guide plate 30 to form a partial bright area easily, so that the invention can prevent the non-uniform light issue of the backlight module effectively.

On the other hand, the cross-sectional upper edge 232 as shown in FIG. 6 having a greater curvature is provided for emitting a light with a greater divergence angle from the light emitting chip 22, so that after the light is passed through the lateral side of the light guide plate 30 and projected onto the light guide plate 30, the light can be diffused with a large angle in the light guide plate 30 to further improve the uniformity of the light emitted from the backlight module.

While the invention has been described by means of specific embodiments, numerous modifications and variations could be made thereto by those skilled in the art without departing from the scope and spirit of the invention set forth in the claims.

1. A light emitting diode (LED) device applied to a backlight module, comprising:
a substrate;
a plurality of sub-substrates, installed on the substrate;
a plurality of light emitting chips, removably installed on the sub-substrates respectively; and
a plurality of package lenses, removably installed on the light emitting chips respectively, and each lens being in a solid semi-elliptical shape, and having a long axis and a short axis perpendicular to the long axis.

2. The LED device applied to a backlight module as recited in claim 1, wherein the substrate is in a rectangular shape, and the substrate has a long axis substantially parallel to the long axis of the package lens.

3. The LED device applied to a backlight module as recited in claim 1, wherein the light emitting chip is a cuboid, and the cuboid has a long axis substantially parallel to the long axis of the package lens.

4. The LED device applied to a backlight module as recited in claim 1, wherein the package lens is made of silicone.

5. The LED device applied to a backlight module as recited in claim 4, wherein the silicone is capable of passing a visible light having a wave band from 400 nm to 780 nm.

6. The LED device applied to a backlight module as recited in claim 1, wherein the package lens has a length equal to or greater than 0.5 mm.

7. The LED device applied to a backlight module as recited in claim 1, wherein the long axis has a length greater than the length of the short axis.

8. The LED device applied to a backlight module as recited in claim 1, wherein the package lens includes phosphor scattered therein.
